(19) United States
(12) Patent Application Publication
(10) Pub. No.: US 2007/0272504 A1
(43) Pub. Date: Nov. 29, 2007

(54) Electric parking brake device

(76) Inventor: Tomoyasu Sakai, Kariya-city (JP)

Correspondence Address: BUCHANAN, INGERSOLL & ROONEY PC, POST OFFICE BOX 1404, ALEXANDRIA, VA, 22313-1404, US

(21) Appl. No.: 11/798,764

(22) Filed: May 16, 2007

(30) Foreign Application Priority Data
May 25, 2006 (JP) 2006-145320

(51) Int. Cl. F16D 65/14

(52) U.S. Cl. 188/2 D

(57) ABSTRACT

An electric parking brake device comprises an electric motor, a conversion mechanism for converting a rotational drive force given by the electric motor into a linear drive force and a pair of cables (i.e., inner cables) connected to a pair of parking brakes, wherein the parking brakes are brought into a braking state when the cables are drawn in a drawing direction by the operation of the electric motor in a positive-going direction, but are brought into a release state when the cables are returned in a return direction by the operation of the electric motor in a reverse direction. Between the electric motor and the conversion mechanism, a clutch mechanism is provided for transmitting the rotation of the electric motor to the conversion mechanism, but for blocking the rotation transmission from the conversion mechanism toward the electric motor. An auxiliary force applying member comprising any one of a compression spring, a tension spring and a torsion spring is provided for applying an auxiliary force to the conversion mechanism when the same is operated to draw the cables in the braking operation of the cables.

### INCORPORATION BY REFERENCE

This application is based on and claims priority under 35 U.S.C. 119 with respect to Japanese Application No. 2006-145320 filed on May 25, 2006, the entire content of which is incorporated herein by reference.

### BACKGROUND OF THE INVENTION

1. Field of the Invention

The present invention relates to an electric parking brake device which converts a rotational drive force of an electric motor to a linear drive force for transmitting the same to one or more parking brakes.

2. Discussion of the Related Art

Heretofore, there has been known an electric parking brake device described in Japanese unexamined, published patent application No. 2005-16600. The device is provided with an electric motor, a reduction mechanism for transmitting the rotational drive force of the electric motor at a reduced speed, a conversion mechanism for converting the rotational drive force from the reduction mechanism into a linear drive force, and cables for transmitting the linear drive force to parking brakes.

In this electric parking brake device, the parking brakes are brought into a braking state when the cables are drawn upon a positive-going rotation of the electric motor, but are brought into a release state when the cables are returned upon a reverse rotation of the electric motor. Further, since a release restriction mechanism restricts the return operation of the cables when the parking brakes are released, the cables can be prevented from being returned through a longer distance than as required, so that responsiveness can be enhanced in bringing the parking brakes into the braking operation.

However, in the aforementioned prior art parking brake device, when the parking brakes are brought into the braking state, the cables have to be tensioned against their tensions, and this applies a substantial load to the electric motor and the reduction mechanism, so that there has been a certain degree of limitation on downsizing the device.

### SUMMARY OF THE INVENTION

Accordingly, it is a primary object of the present invention to provide an improved electric parking brake device capable of being downsized as well as of enhancing the responsiveness at the time of the braking operation of a parking brake.

Briefly, according to the present invention, there is provided an electric parking brake device, which comprises an electric motor; a conversion mechanism provided in a housing for converting a rotational drive force given by the electric motor into a linear drive force; and at least one cable for transmitting the linear drive force from the conversion mechanism to at least one parking brake; wherein the at least one parking brake is brought into a braking state when the at least one cable is drawn in a drawing direction by the operation of the electric motor in a positive-going direction, but is brought into a release state when the at least one cable is returned in a return direction by the operation of the electric motor in a reverse direction. The electric parking brake device further comprises a clutch mechanism for transmitting the rotation of the electric motor to the conversion mechanism, but for blocking the rotation transmission from the conversion mechanism toward the electric motor; and auxiliary force applying means for conserving energy in the return direction of the at least one cable and for applying an auxiliary force depending on the energy, in the drawing direction of the cable.

With this configuration, because the auxiliary force applying means is provided for conserving energy in the return direction of the at least one cable and for applying an auxiliary force, depending on the conserved energy, in the drawing direction of the at least one cable, the energy is conserved in the auxiliary force applying means at the time of the release operation (at the time of cable return) in which any substantial load is not imposed on the electric motor and the like, and the conserved energy can be utilized at the time of the braking operation of the at least one parking brake (at the time of cable drawing) in which a substantial load is imposed on the electric motor and the like. Thus, it becomes possible to make small the load imposed on the electric motor and the like. Further, because of the provision of the clutch mechanism which is capable of transmitting rotation in one direction only from the electric motor to the conversion mechanism, the braking state of the at least one parking brake can be held even when the application of electricity to the electric motor is discontinued, so that it becomes possible to make small the reduction ratio between the electric motor and the clutch mechanism. Further, it becomes possible to positively utilize the auxiliary force conserved in the auxiliary force applying means. Accordingly, it can be realized to downsize the parking brake device and to enhance the responsiveness at the time of the braking operation of the at least one parking brake.

### BRIEF DESCRIPTION OF THE ACCOMPANYING DRAWINGS

The foregoing and other objects and many of the attendant advantages of the present invention may readily be appreciated as the same becomes better understood by reference to the preferred embodiments of the present invention when considered in connection with the accompanying drawings, wherein like reference numerals designate the same or corresponding parts throughout several views, and in which:

FIG. 1 is a plan view of an automotive electric parking brake device in a release state of parking brakes in a first embodiment according to the present invention;

FIG. 2 is an enlarged cross-section taken along the line II-II in FIG. 1 of a one-way clutch;

FIG. 3 is a longitudinal sectional view of the one-way clutch shown in FIG. 2;

FIG. 4 is a plan view of the automotive electric parking brake device in a braking state of the parking brakes in the first embodiment;

FIG. 5 is a graph showing the relation between the tension of cables and the auxiliary force of a spring for first to third embodiments according to the present invention;

FIG. 6 is a plan view of an automotive electric parking brake device in a second embodiment according to the present invention; and

FIG. 7 is a plan view of an automotive electric parking brake device in a third embodiment according to the present invention.

### DETAILED DESCRIPTION OF THE PREFERRED EMBODIMENTS

### First Embodiment

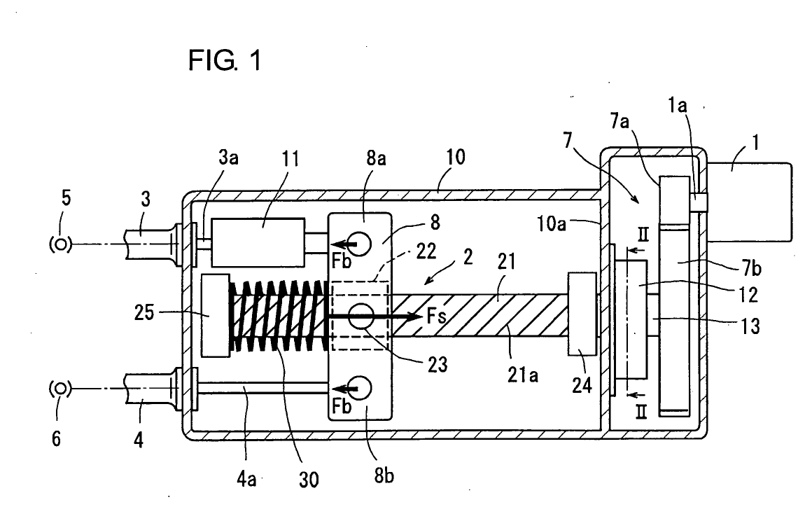

Hereafter, an electric parking device in a first embodiment according to the present invention will be described with reference to FIGS. 1 to 5. The electric parking brake device in the present embodiment comprises a housing 10, an electric motor 1 mounted on the housing 10, a conversion mechanism 2 for converting the rotational drive force of the electric motor 1 into a linear drive force, and a pair of cables, each composed of outer and inner cables 3, 3a or 4, 4a, for transmitting the linear drive motion from the conversion mechanism 2 to a pair of parking brakes 5, 6 schematically illustrated herein. One-way clutch 12 as a clutch mechanism is provided between the electric motor 1 and the conversion mechanism 2, and an equalizer 8 as a movable member and a compression spring 30 made of an elastic member as auxiliary force applying means are provided between the conversion mechanism 2 and the cables. Further, a tension sensor 11 is provided between the equalizer 8 and one of the cables or the inner cable 3a. The conversion mechanism 2, a reduction gear 7, the one-way clutch 12, the equalizer 8, the compression spring 30 and the tension sensor 11 are all contained in the housing 10. Although in the present particular embodiment, an ECU (electric control unit: not shown) is arranged outside the housing 10, the ECU may be contained in the housing 10.

The electric motor 1 is controllable by the ECU and is driven in a positive-going direction by the driver's manipulation of a brake switch (not shown), but is driven in a reverse direction by the driver's manipulation of a release switch (not shown). Thus, when the electric motor 1 is driven in the positive-going direction, the inner cables 3a, 4a are drawn in a drawing direction (the rightward direction as viewed in FIG. 1) to bring the parking brakes 5, 6 into a braking state. On the other hand, when the electric motor 1 is driven in the reverse direction, the inner cables 3a, 4a are drawn in a return direction (the leftward direction as viewed in FIG. 1) to bring the parking brakes 5, 6 into a release state.

The reduction gear 7 is for transmitting the rotational drive force of the electric motor 1 to the conversion mechanism 2 at a reduced speed and is composed of a small reduction gear 7a and a large reduction gear 7b. The small reduction gear 7a is fixed on a motor shaft 1a of the electric motor 1, whereas the large reduction gear 7b is fixed on an input shaft 13 referred to later.

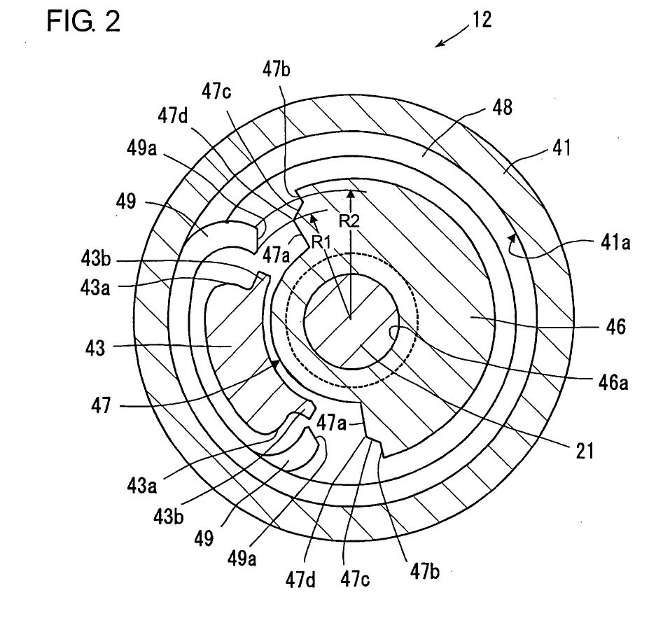

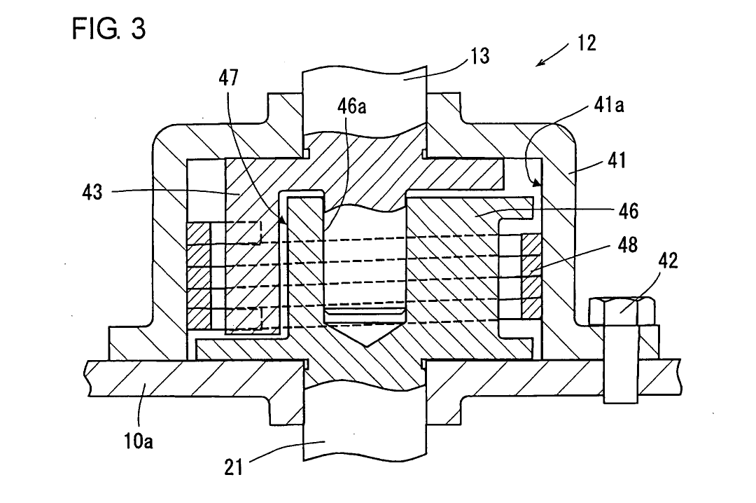

The one-way clutch 12 is fixed on a partition wall 10a provided at an intermediate part of the housing 10 and transmits the rotation of the electric motor 1 to the conversion mechanism 2, but blocks the rotation transmission from the conversion mechanism 2 toward the electric motor 1. The input shaft 13 and a screw shaft 21 referred to later of the conversion mechanism 2 are protruded from the one-way clutch 12 in mutually opposite directions and in axial alignment with each other. As shown in FIGS. 2 and 3, primary components of the one-way clutch 12 are a cylinder member 41, an input cam 43 provided on the input shaft 13, an output cam 46 provided on the screw shaft 21, and a coil spring 48. The cylinder member 41 is fixed on the partition wall 10a by means of bolts 42 and has a cylindrical internal surface 41a inside. The input cam 43 is formed on one end of the input shaft 13 bodily and coaxially, and the output cam 46 is formed on one end of the screw shaft 21 bodily and coaxially.

As shown in FIG. 2, a sector cutout 47 taking its center on the rotational axis of the screw shaft 21 is formed at a part of the circumference of the output cam 46, and a cylindrical hole 46a is coaxially formed at the center part of the output cam 46. Respective inner end surfaces 47a at opposite ends in the circumferential direction of the cutout 47 extend radially. Each of the circumferentially inner end surfaces 47a has formed at its outside end portion an oblique surface (partly, a cam surface) 47c which extends radially outward at an obtuse angle and also has formed thereon a short outside end surface 47b which further extends radially from the outside end of the oblique surface 47c to reach the circumferential surface of the output cam 46. The oblique surface 47c and the outside end surface 47b define parts of each circumferentially inner end surface 47a.

The input cam 43 takes a sector-shape, which is inserted into the cutout 47 of the output cam 46 with clearances being secured circumferentially with respect to both inner end surfaces 47a. A pair of arc shape protruding portions 43b which protrude toward the circumferentially inner end surfaces 47a of the cutout 47 of the output cam 46 are formed at radially inside end portions of the circumferentially outer end surfaces 43a of the input cam 43. Between the internal surface 41a of the cylinder member 41 and the external surfaces of the input cam 43 and the output cam 46, there is defined an annular space sufficient to contain the coil spring 48 described below.

The coil spring 48 is plural in the number of turns (four or more turns in the illustrated example) and is received in friction engagement with the internal surface 41a of the cylinder member 41 by being pressured resiliently. The both end portions of the coil spring 48 are curved by about 90 degrees radially inward along an arc whose radius is relatively large and define curved portions 49 whose extreme ends are placed respectively in the clearances between the circumferentially outer end surfaces 43a of the input cam 43 and the circumferentially inner end surfaces 47a of the cutout 47. The end surface 49a of each curved portion 49 of the coil spring 48 takes a cam surface which is inclined so that as shown in FIG. 2, the distance or radius R1 between one end thereof intersecting with the inside surface of the curved portion 49 and the rotational center of the output cam 46 is made to be shorter than the distance or radius R2 between the other end thereof intersecting with the outside surface of the curved portion 49 and the rotational center of the output cam 46. Thus, a dimensional relation is made for the cam surface 49a to come into contact with a corner or edge portion 47d which is at the juncture between the circumferentially inner end surface 47a and the oblique surface 47c on either circumferential side of the cutout 47. Further, the length of each protruding portion 43b is set to such a dimension that a clearance is provided between the cam surface 49a at the end of the curved portion 49 and the edge portion 47d on the circumferentially inner end surface 47a in the state that each such protruding portion 43b is held in contact with the circumferentially inner end surface 47a of the cutout 47 and that the inside surface of the curved portion 49 is held in contact with the circumferentially outer end surface 43a of the input cam 43.

As shown in FIG. 1, the conversion mechanism 2 is for converting the rotational drive power of the electric motor 1 transmitted through the reduction gear 7 into a linear drive power and is provided with the screw shaft 21, which has formed on its external surface a screw 21a of two turns being large in lead, and a nut 22 assembled on the screw shaft 21 with screw engagement therewith. Further, the screw shaft 21 is assembled in the housing 10 to be rotatable and axially immovable through a pair of bearings 24, 25.

The equalizer 8 is for equally dividing the linear drive power acting on the nut 22 into two outputs and is attached at its center part to the nut 22 to be pivotable about a pivot pin 23. An arm portion 8a being one output portion of the equalizer 8 is pivotally jointed to the inner cable 3a in the outer cable 3 on one side through a tension sensor 11, whereas another arm portion 8b being the other output portion is jointed directly to the inner cable 4a in the outer cable 4 on the other side. The tension sensor 11 is for detecting the tension Fb acting on the inner cable 3a (i.e., on the equalizer 8).

The compression spring 30 is wound around the screw shaft 21 between the equalizer 8 and the bearing 25. The spring 30 is secured to the equalizer 8 at its one end and to the bearing 25 at its other end. Thus, the equalizer 8 is urged by an auxiliary force Fs of the compression spring 30 in the drawing direction of the inner cables 3a, 4a (i.e., in the rightward direction as viewed in the FIG. 1). In the automotive electric parking brake device, the compression spring 30 is employed, so that it can be realized to utilize the elastic or resilient force of the compression spring 30 as the auxiliary force Fs. That is, at the release time of the parking brakes 5, 6 (at the time of cable return), energy is conserved through the compression of the compression spring 30, while at the braking time of the parking brakes 5, 6 (at the time of cable drawing), the conserved energy (i.e., the elastic force) can be utilized to facilitate the rightward movement of the nut 22 and the equalizer 8.

### (Operation)

The operation of the automotive electric parking brake device as constructed above will be described hereinafter. In the state shown in FIG. 1, the inner cables 3a, 4a have been returned, so that the parking brakes 5, 6 are in the release state. Further, sufficient elastic energy has been conserved in the compression spring 30 having been compressed. In this state, when the driver manipulates the brake switch (not shown), the motor shaft 1a of the electric motor 1 is drivingly rotated by an ECU (electric controller) in a positive-going direction. The rotational drive power of the motor shaft 1a of the electric motor 1 is reduced in speed by the reduction gear 7 composed of the small reduction gear 7a and the large reduction gear 7b and is transmitted to the input shaft 13.

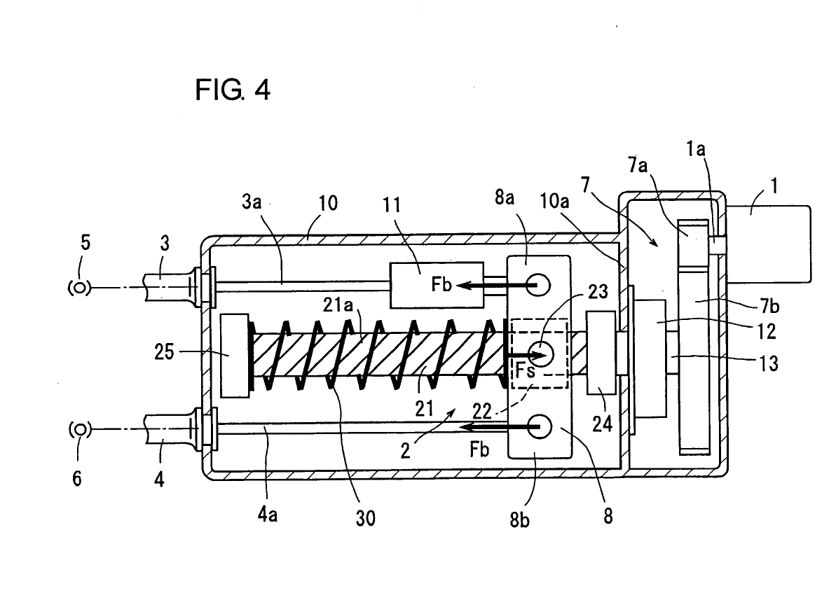

With the rotation of the input shaft 13, the input cam 43 secured to the input shaft 13 is also rotated, and at first, the circumferentially outer end surface 43a on one side (e.g., a clockwise end side as viewed in FIG. 2) is brought into contact with the inside of the curved portion 49 on the same side of the coil spring 48 to pressure the curved portion 49. Because this pressure force serves to contract the outer diameter of the coil spring 48, the same is rotated to follow the rotation of the input cam 43. Then, the protruding portion 43b on the same side of the input cam 43 is brought into contact with the circumferentially inner end surface 47a of the cutout 47 to push the output cam 46. As the input shaft 13 is rotated in this way, the screw shaft 21 is drivingly rotated in the positive-going direction, whereby the nut 22 and the equalizer 8 attached to the nut 22 are moved toward the right as viewed in FIG. 1. With the movement of the equalizer 8, the inner cables 3a, 4b jointed to the arm portions 8a, 8b of the equalizer 8 are drawn to draw the inner cables 3a, 4a. At this time, the movement of the equalizer 8 is facilitated by being urged by the auxiliary force Fs of the compression spring 30 in the drawing direction of the inner cables 3a, 4a (i.e., in the rightward direction in FIG. 1). Further, although the inner cables 3a and 4a (the equalizer 8) do not have so much large tension Fb applied thereto with the parking brakes 5, 6 being not placed in a sufficient braking state, but do have a large tension Fb applied thereto when the brake forces are applied to the parking brakes 5, 6. When the output of the tension sensor 11 becomes a predetermined value or higher, the ECU (electric controller) turns an indicator lamp (not shown) on and discontinues the rotation of the electric motor 1. In this way, the parking brakes 5, 6 are brought into the braking state, whereby the automotive electric parking brake device is brought into the state shown in FIG. 4.

In the state shown in FIG. 4, the equalizer 8 and the nut 22 have been drawn by the inner cables 3a, 4a with a large tension Fb in the return direction of the inner cables 3a, 4a (i.e., in the leftward direction in the figure). In this state, if the tension Fb serves to rotate the screw shaft 21 reversely or in a negative-going direction and hence, tends to transmit the reverse rotation toward the input shaft 13 side, the output cam 46 secured to the screw shaft 21 is rotated slightly from an inoperative state shown in FIG. 2, whereby the edge portion 47d of the circumferential inner end portion 47a which precedes in the reverse rotational direction of the screw shaft 21 is brought into contact with the cam surface 49a of the curved portion 49 of the coil spring 48 to pressure against the cam surface 49a. This pressure force serves to expand the outer diameter of the coil spring 48 and also serves to pressure the neighborhood of the curved portion 49 of the coil spring 48 against the internal surface 41a of the cylinder member 41. Thus, the coil spring 48 is prevented from being slidden along the internal surface 41a of the cylinder member 41, whereby not only is no rotation transmitted to the input shaft 13 side, but the rotation of the screw shaft 12 itself is also prevented. Therefore, the braking state of the parking brakes 5, 6 can be held while the application of electricity to the electric motor 1 is discontinued.

On the other hand, when the driver manipulates the release switch (not shown) in the braking state shown in FIG. 4, the motor shaft 1a of the electric motor 1 is drivingly rotated by the ECU (electric controller) in the reverse or negative-going direction. The rotational drive force of the motor shaft 1a of the electric motor 1 is reduced in speed by the reduction gear 7 composed of the small reduction gear 7a and the large reduction gear 7b and is transmitted to the input shaft 13.

When the input shaft 13 is rotated in the reverse direction, the input cam 43 secured to the input shaft 13 is rotated in the direction opposite to the direction in which it was rotated in the aforementioned braking operation of the parking brakes 5, 6, and the circumferentially outer end surface 43a on the side opposite to that in the aforementioned case (i.e., on the counterclockwise end side as viewed in FIG. 2) is brought into contact with the inside of the curved portion 49 of the coil spring 48 to pressure the curved portion 49. Because this pressure force serves to contract the outer diameter of the coil spring 48, the same is rotated to follow the rotation of the input cam 43. Then, the protruding portion 43b on the same side of the input cam 43 is brought into contact with the circumferentially inner end surface 47a of the cutout 47 to push the output cam 46. As the input shaft 13 is rotated reversely in this way, the screw shaft 21 is drivingly rotated in the reverse or the negative-going direction, whereby the nut 22 and the equalizer 8 attached to the nut 22 are moved toward the left as viewed in FIG. 4. The inner cables 3a, 4b jointed to the arm portions 8a, 8b of the equalizer 8 are returned with the movement of the equalizer 8. At this time, the compression spring 30 is compressed by the equalizer 8 in the return direction of the inner cables 3a, 4a (i.e., in the leftward direction in the FIG. 4), whereby the elastic energy is conserved. Further, although the tension Fb of a certain degree is being applied to the inner cables 3a, 4a (the equalizer 8) with the parking brakes 5, 6 being not fully placed in the release state, a substantial tension Fb is hardly applied to the inner cables 3a, 4a (the equalizer 8) when the parking brakes 5, 6 are brought into the release state. When the output of the tension sensor 11 becomes less than the predetermined value, the ECU (electric controller) extinguishes the indicator lamp and discontinues the rotation of the electric motor 1. In this way, the parking brakes 5, 6 are brought into the release state, whereby the automotive electric parking brake device is brought into the release state shown in FIG. 1.

In the release state shown in FIG. 1, the equalizer 8 and the nut 22 are being urged by the auxiliary force Fs of the compression spring 30 in the drawing direction of the inner cables 3a, 4a (in the rightward direction in FIG. 1). Thus, if the auxiliary force Fb serves to rotate the screw shaft 21 in the positive-going direction and hence, tends to transmit the rotation toward the input shaft 13 side, the output cam 46 secured to the screw shaft 21 is rotated slightly from the inoperative state shown in FIG. 2 in the clockwise direction as viewed in FIG. 2, whereby the edge portion 47d of the circumferential inner end portion 47a which precedes in the clockwise rotational direction of the screw shaft 21 is brought into contact with the cam surface 49a of the curved portion 49 of the coil spring 48 to pressure against the cam surface 49a. This pressure force serves to expand the outer diameter of the coil spring 48 and also serves to pressure the neighborhood of the curved portion 49 of the coil spring 48 against the internal surface 41a of the cylinder member 41. Thus, the coil spring 48 is prevented from being slidden along the internal surface 41a of the cylinder member 41, whereby not only is no rotation transmitted to the input shaft 13 side, but the rotation of the screw shaft 12 itself in the positive going direction is also prevented. In this way, the release state of the parking brakes 5, 6 can be held while the application of electricity to the electric motor 1 is discontinued.

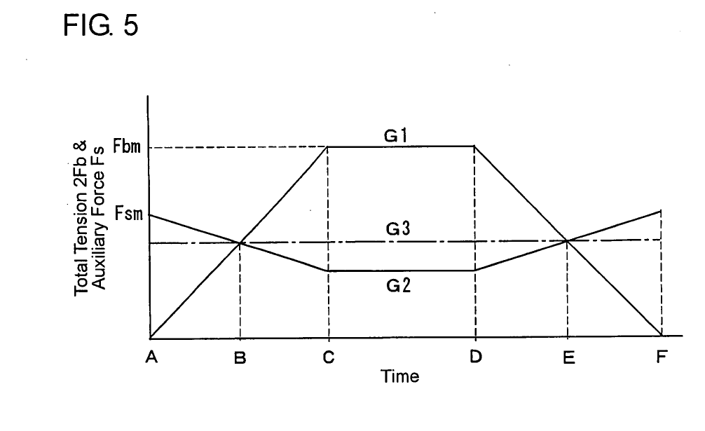

With reference to FIG. 5, description will then be made regarding the relation between the tension Fb of the inner cables 3a, 4a and the auxiliary force Fs of the compression spring 30 in the operation of the automotive electric parking brake device. In FIG. 5, the graph G1 represents a total tension (2×Fb) of the inner cables 3a, 4a, the graph G2 represents the auxiliary force Fs of the compression spring 30, and the graph G3 represents the auxiliary force Fs of the compression spring 30 in the ideal state. In this graph, the axis of ordinate indicates the magnitude of the total tension (2×Fb) and the auxiliary force Fs, whereas the axis of abscissas indicates time. Time A is when the parking brakes 5, 6 are in the release state shown in FIG. 1, wherein the total tension (2×Fb) of the inner cables 3a, 4a is approximately zero. Further, the auxiliary force Fs of the compression spring 30 is held in the maximum auxiliary force Fsm. Here, the maximum auxiliary force Fsm of the compression spring 30 is determined in dependence on the maximum tension Fbm of the inner cables 3a, 4a so that the average value of the auxiliary force Fs becomes about one half of the maximum tension Fbm of the inner cables 3a, 4a.

When the driver manipulates the aforementioned brake switch right after the time A, the inner cables 3a, 4a are drawn by the equalizer 8, and the total tension (2×Fb) of the inner cables 3a, 4a becomes larger gradually. Further, the auxiliary force Fs of the compression spring 30 becomes smaller gradually. Then, the total tension (2×Fb) of the inner cables 3a, 4a and the auxiliary force Fs of the compression spring 30 come to equal at time B, and thereafter, the total tension (2×Fb) of the inner cables 3a, 4a becomes greater than the auxiliary force Fs of the compression spring 30. At time C, the parking brakes 5, 6 are brought into the braking state shown in FIG. 4, wherein the total tension (2×Fb) of the inner cables 3a, 4a reaches the maximum tension Fbm, whereas the auxiliary force Fs of the compression spring 30 reaches the minimum. The parking brakes 5, 6 are held in the braking state during the period from time C to time D.

At time D, the driver manipulates the aforementioned release switch, and as a consequence, the inner cables 3a, 4a are fed back, whereby the total tension (2×Fb) of the inner cables 3a, 4a is decreased gradually. At the same time, the auxiliary force Fs of the compression spring 30 is increased gradually. Then, the total tension (2×Fb) of the inner cables 3a, 4a and the auxiliary force Fs of the compression spring 30 come to be equal at time E, and from this point, the auxiliary force Fs of the compression spring 30 comes to be greater than the total tension (2×Fb) of the inner cables 3a, 4a. At time F, the parking brakes 5, 6 are brought into the release state, wherein the total tension (2×Fb) of the inner cables 3a, 4a becomes the minimum, while the auxiliary force Fs of the compression spring 30 becomes the maximum auxiliary force Fsm.

In the automotive electric parking brake device in the first embodiment, because the compression spring 30 for applying the auxiliary force Fs in the drawing direction of the inner cables 3a, 4a is provided between the equalizer 8 and the bearing 25, the compression spring 30 is compressed to conserve energy at the release time of the parking brakes 5, 6 (i.e., at the time of cable return) wherein any substantial load does not act on the electric motor 1 and the reduction gear 7, and the conserved energy can be utilized at the braking time of the parking brakes 5, 6 (i.e., at the time of cable drawing) wherein a substantial load acts on the electric motor 1 and the reduction gear 7. Therefore, it becomes possible to reduce the load acting on the electric motor 1 and the reduction gear 7. Further, because of the provision of the one-way clutch 12 which is able to transmit rotation in one direction only from the input shaft 13 toward the screw shaft 21, the braking state and the release state of the parking brakes 5, 6 can be held upon discontinuation of electricity to the electric motor 1, so that it can be realized to make small the speed reduction ratios of the reduction gear 7 and the conversion mechanism 2. In addition, it is possible to positively utilize the auxiliary force Fs of the compression spring 30 at the braking time of the parking brakes 5, 6 (i.e., at the time of cable drawing). Therefore, according to the automotive electric parking brake device, the downsizing of the electric parking brake device can be realized, and an improvement can be made in responsiveness at the braking time of the parking brakes 5, 6.

Further, in the automotive electric parking brake device, the operation for drawing the inner cables 3a, 4a and the operation for returning the inner cables 3a, 4a can be performed speedily because the screw 21a large in lead is formed on the external surface of the screw shaft 21.

In addition, in the automotive electric parking brake device, the maximum auxiliary force Fsm of the compression spring 30 is set so that the average value of the auxiliary force Fs becomes about one half of the maximum tension Fbm of the inner cables 3a, 4a. Thus, the load acting on the electric motor 1 and the like can be reduced to about one half compared with that in the case of unemployment of the compression spring 30.

### Second Embodiment

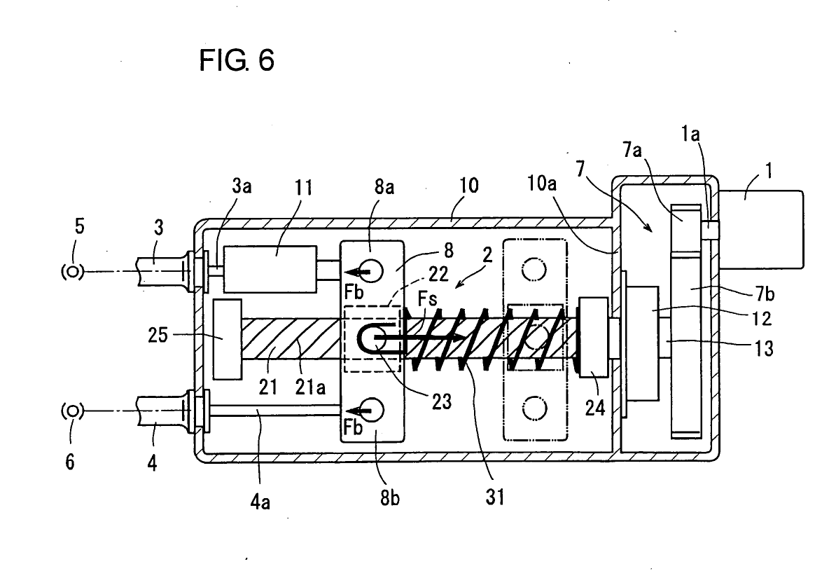

The principal mechanical components of an automotive electric parking brake device in a second embodiment are the same as those in FIG. 1, as shown in FIG. 6. The same components as those in the first embodiment shown in FIG. 1 are designated by the same reference numerals as used in FIG. 1, and description thereof will be omitted for the sake of brevity.

In the automotive electric parking brake device in the second embodiment, a tension spring 31 is wound around the screw shaft 21 between the equalizer 8 and the bearing 24, and the tension spring 31 is secured to the bearing 24 at its one end and is hooked on the pivot pin 23. Thus, the equalizer 8 is urged by the auxiliary force Fs of the tension spring 31 in the drawing direction of the inner cables 3a, 4a (i.e., in the rightward direction as viewed in FIG. 6). In this parking brake device, the tension spring 31 is employed, so that the elastic force of the tension spring 31 can be used as the auxiliary force Fs. That is, the tension spring 31 is stretched to conserve energy at the release time of the parking brakes 5, 6 (i.e., at the time of cable return), and the conserved energy can be utilized at the braking time of the parking brakes 5, 6 (i.e., at the time of cable drawing).

The operation of the parking brake device in the second embodiment is the same as that of the parking brake device in the foregoing first embodiment. FIG. 6 shows the release state of the parking brakes 5, 6. In the braking state of the parking brakes 5, 6, the equalizer 8 takes the position indicated by the two-dot-chain line in FIG. 6. The same effects as those described with respect to the parking brake device in the foregoing first embodiment can also be attained in the parking brake device in the second embodiment.

### Third Embodiment

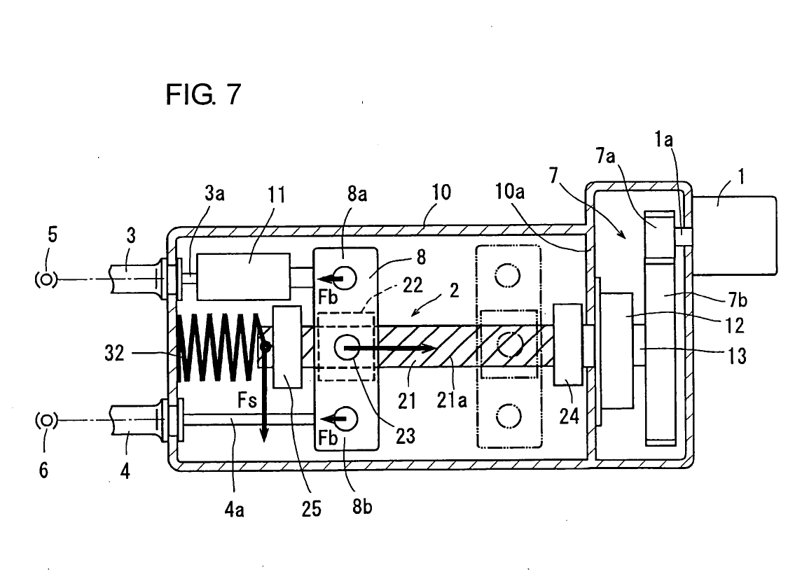

The principal mechanical components of an automotive electric parking brake device in a third embodiment are the same as those in FIG. 1, as shown in FIG. 7. The same components as those in the first embodiment shown in FIG. 1 are designated by the same reference numerals as used in FIG. 1, and description thereof will be omitted for the sake of brevity.

In the automotive electric parking brake device in the third embodiment, a torque spring 32 is interposed between an extreme end of the screw shaft 21 and the housing 10, wherein one end of the torque spring 32 is hooked on the extreme end of the screw shaft 21, while the other end of the torque spring 32 is fixed on the housing 10. The auxiliary force Fs of the torsion spring 32 applies a force to the screw shaft 12 in such a direction as to rotate the screw shaft 12 in the positive-going direction. This force is transmitted through the screw 21a and the nut 22, whereby the equalizer 8 is urged in the drawing direction of the inner cables 3a, 4a (i.e., in the rightward direction as viewed in FIG. 7). In this parking brake device, the torsion spring 32 is employed, so that the elastic force of the torsion spring 32 can be used as the auxiliary force Fs. That is, the torsion spring 31 is twisted to conserve energy at the release time of the parking brakes 5, 6 (i.e., at the time of cable return), and the conserved energy can be utilized at the braking time of the parking brakes 5, 6 (i.e., at the time of cable drawing).

The operation of the parking brake device in the third embodiment is the same as that of the parking brake device in the foregoing first embodiment. FIG. 7 shows the release state of the parking brakes 5, 6. In the braking state of the parking brakes 5, 6, the equalizer 8 takes the position indicated by the two-dot-chain line in FIG. 7. The same effects as those described with respect to the parking brake device in the foregoing first embodiment can also be attained in the parking brake device in the third embodiment. However, there is a difference in that each of the first and second embodiments utilizes the auxiliary force Fs of the compression spring 30 or the tension spring 31 to directly urge the equalizer 8, whereas the third embodiment utilizes the auxiliary force Fs of the torsion spring 32 to indirectly urge the equalizer 8.

As described hereinabove, in the parking brake device in any one of the foregoing first to third embodiments, because the auxiliary force applying means 30, 31 or 32 is provided for conserving energy in the return direction of the cables 3, 4 (i.e., the inner cables 3a, 4a) and for applying an auxiliary force, depending on the conserved energy, in the drawing direction of the cables 3, 4, the energy is conserved in the auxiliary force applying means 30, 31 or 32 at the release time of the parking brakes 5, 6 (at the time of cable return) in which any substantial load is not imposed on the electric motor 1 and the like, and the conserved energy can be utilized at the braking time of the parking brake 5, 6 (at the time of cable drawing) in which a substantial load is imposed on the electric motor 1 and the like. Thus, it becomes possible to make small the load imposed on the electric motor 1 and the like. Further, because of the provision of the clutch mechanism 12 which is capable of transmitting rotation in one direction only from the electric motor 1 to the conversion mechanism 2, the braking state of the parking brake 5, 6 can be held even when the application of electricity to the electric motor 1 is discontinued, so that it becomes possible to make small the reduction ratio between the electric motor 1 and the clutch mechanism 2. Further, it becomes possible to positively utilize the auxiliary force conserved in the auxiliary force applying means 30, 31 or 32. Accordingly, it can be realized to downsize the electric parking brake device and to enhance the responsiveness at the braking time of the parking brake 5, 6.

Also in the parking brake device in any one of the foregoing first to third embodiments, because the large lead screw 21a is formed on the external surface of the screw shaft 21, it can be realized to perform the drawing and return operations of the cables 3, 4 (i.e., the inner cables 3a, 4a) speedily or quickly.

Also in the parking brake device in any one of the foregoing first to third embodiments, the maximum auxiliary force Fsm of the auxiliary force applying means 30, 31 or 32 is set to be smaller than the maximum tension force Fbm of the cables 3, 4 (i.e., the inner cables 3a, 4a), it can be avoided that a load which exceeds that necessary acts on the electric motor 1 or the like at the release time of the parking brakes 5, 6 wherein energy is conserved in the auxiliary force applying means 30, 31 or 32.

Also in the parking brake device in any one of the foregoing first to third embodiments, because the auxiliary force applying means is constituted by an elastic member 30, 31 or 32, not only can the elastic force be utilized as the auxiliary force Fs, but the electric parking brake device can also be simplified in construction.

In the parking brake device in any one of the foregoing first and second embodiments, because the elastic member is the compression spring 30 or the tension spring 31 which is arranged between a movable member (the nut 22 or the equalizer 8) connected to the cables 3, 4 (i.e., the inner cables 3a, 4a), energy is conserved by compressing the compression spring 30 or by stretching the tension spring 31 at the release time of the parking brakes 5, 6 (i.e., at the time of cable return), and the conserved energy can be utilized at the braking time of the parking brakes 5, 6 (at the time of cable drawing). In addition, it can be realized to simplify the electric parking brake device in construction.

In the parking brake device in the foregoing third embodiment, because the elastic member is the torsion spring 32 arranged between the screw shaft 21 and the housing 10, energy is conserved by twisting the torsion spring 32 at the release time of the parking brakes 5, 6 (i.e., at the time of cable return), and the conserved energy can be utilized at the braking time of the parking brakes 5, 6 (at the time of cable drawing). In addition, it can be realized to simplify the electric parking brake device in construction.

Obviously, numerous further modifications and variations of the present invention are possible in light of the above teachings. It is therefore to be understood that within the scope of the appended claims, the present invention may be practiced otherwise than as specifically described herein.

What is claimed is:

1. An electric parking brake device comprising:
an electric motor;
a conversion mechanism provided in a housing for converting a rotational drive force given by the electric motor into a linear drive force; and
at least one cable for transmitting the linear drive force from the conversion mechanism to at least one parking brake;
wherein the at least one parking brake is brought into a braking state when the at least one cable is drawn in a drawing direction by the operation of the electric motor in a positive-going direction, but is brought into a release state when the at least one cable is returned in a return direction by the operation of the electric motor in a reverse direction, the device further comprising:
a clutch mechanism for transmitting the rotation of the electric motor to the conversion mechanism, but for blocking the rotation transmission from the conversion mechanism toward the electric motor; and
auxiliary force applying means for conserving energy in the return direction of the at least one cable and for applying an auxiliary force depending on the energy, in the drawing direction of the at least one cable.

2. The electric parking brake device as set forth in claim 1, wherein the conversion mechanism includes a screw shaft rotatable by the electric motor, and wherein a large lead screw is formed on the external surface of the screw shaft.

3. The electric parking brake device as set forth in claim 1, wherein the maximum auxiliary force (Fsm) of the auxiliary force applying means is smaller than the maximum tension (Fbm) of the at least one cable.

4. The electric parking brake device as set forth in claim 1, wherein the auxiliary force applying means comprises an elastic member.

5. The electric parking brake device as set forth in claim 4, wherein:
the conversion mechanism includes a movable member connected to the at least one cable and movable in the moving direction of the at least one cable; and
the elastic member comprises either a compression spring or a tension spring which is arranged between the movable member and the housing.

6. The electric parking brake device as set forth in claim 5, wherein:
the at least one cable comprises a pair of cables for transmitting the linear drive force from the conversion mechanism to a pair of parking brakes including the at least one parking brake;
the conversion mechanism includes a screw shaft rotatable by the electric motor and having a large lead screw formed on the external surface thereof and a nut engaged on the large lead screw to be reciprocatively movable along the screw shaft; and
the movable member is an equalizer pivotally carried on the nut and connected to the pair of cables at opposite ends thereof.

7. The electric parking brake device as set forth in claim 2, wherein:
the auxiliary force applying means comprises a torsion spring arranged between the screw shaft and the housing for urging the screw shaft to rotate.

8. An electric parking brake device comprising:
a housing;
an electric motor mounted on the housing;
a conversion mechanism provided in the housing for converting a rotational drive force given by the electric motor into a linear drive force and including a linear motion member movable to reciprocate along a linear path upon operation of the electric motor;
an equalizer pivotably carried on the linear motion member and extending opposite end portions thereof in a direction transversal to the linear path;
a pair of cables respectively connected to the opposite end portions of the equalizer for transmitting the movement of the linear motion member to a pair of parking brakes;
wherein the parking brakes are brought into a braking state when the cables are drawn in a drawing direction by the operation of the electric motor in a positive-going direction, but is brought into a release state when the cables are returned in a return direction by the operation of the electric motor in a reverse direction, the device further comprising:
a clutch mechanism for transmitting the rotation of the electric motor to the conversion mechanism to reciprocate the linear motion member, but for blocking the rotation transmission from the conversion mechanism toward the electric motor; and
auxiliary force applying means for conserving energy in the return direction of the cables, but applying an auxiliary force depending on the energy, in the drawing direction of the cables.

9. The electric parking brake device as set forth in claim 8, wherein the conversion mechanism further includes:
a screw shaft rotatable by the electric motor and having a large lead screw formed on the external surface thereof; and
a nut engaged on the large lead screw to operate as the linear motion member;
wherein the auxiliary force applying means is arranged to urge the linear motion member in the drawing direction of the cables.

10. The electric parking brake device as set forth in claim 9, wherein the auxiliary force applying means comprises either a compression spring or a tension spring which is arranged between the equalizer and the housing.

11. The electric parking brake device as set forth in claim 9, wherein the auxiliary force applying means comprises a torsion spring arranged between the screw shaft and the housing for urging the screw shaft to rotate in the drawing direction of the cables.
